(19) United States
(12) Patent Application Publication
(10) Pub. No.: US 2025/0077496 A1
(43) Pub. Date: Mar. 6, 2025

(54) Hybrid Time-Series Vector Databases with Large-Scale Parallelized Connection Handling for Provision of Vector Embedding Services

(71) Applicant: KX Systems, Inc, New York, NY (US)

(72) Inventor: Charles Skelton, Zurich (CH)

(21) Appl. No.: 18/825,691

(22) Filed: Sep. 5, 2024

Related U.S. Application Data
(60) Provisional application No. 63/580,622, filed on Sep. 5, 2023.

(51) Int. Cl. G06F 16/22; G06F 16/2458; G06N 3/0455; G06N 3/084

(52) U.S. Cl. CPC G06F 16/2237; G06F 16/2477; G06N 3/0455; G06N 3/084

(57) ABSTRACT

Vectorization requests are received via active connections for a hybrid time-series vector database that include input including information associated with an event and temporal information. The inputs are processed with a machine-learned vector embedding model to generate vector representations. The vector representations are mapped to corresponding locations within an embedding portion of the hybrid time-series vector database. A query is received for the hybrid time-series vector database via an active connection of the plurality of active connections. Responsive to the query, a first vector representation is retrieved based at least in part on the location to which the first vector representation is mapped.

### PRIORITY CLAIM

The present application claims priority to, and the benefit of, U.S. Provisional Patent Application No. 63/580,622, having a filing date of Sep. 5, 2023. Applicant incorporates the application herein by reference in its entirety.

### FIELD

The present disclosure relates generally to vector-based databases. More particularly, the present disclosure relates to hybrid time-series vector databases that utilize large-scale parallelized connection handling to provide vector embedding services.

### BACKGROUND

Vector embeddings are numerical representations of words, sentences, video, images, audio, or any other type of information. Vector embeddings are used machine-learned models, such as Large Language Models (LLMs), to facilitate efficient analysis and manipulation of any kind of unstructured data. By converting unstructured data into vector embeddings, machine-learned models can efficiently and accurately perform tasks such as querying, classification, and applying machine learning algorithms on unstructured data.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for vector embedding via hybrid time-series vector databases. The method includes receiving, by a computing system comprising one or more processor devices, a plurality of vectorization requests via a plurality of active connections for a hybrid time-series vector database, wherein each of the plurality of vectorization requests comprises an input of a corresponding plurality of inputs. The plurality of inputs comprises information associated with an event; and temporal information indicative of a time at which the event occurred. The method includes processing, by the computing system, the plurality of inputs with a machine-learned vector embedding model to generate a corresponding vector representation of a plurality of vector representations, wherein a temporal portion of the vector representation represents the temporal information. The method includes, for each of the plurality of vector representations, mapping, by the computing system, the vector representation to a corresponding location of a plurality of locations within an embedding portion of the hybrid time-series vector database based at least in part on the temporal portion of the vector representation. The method includes receiving, by the computing system, a query for the hybrid time-series vector database via an active connection of the plurality of active connections. The method includes, responsive to the query, retrieving, by the computing system, a first vector representation of the plurality of vector representations based at least in part on the location to which the first vector representation is mapped.

Another example aspect of the present disclosure is directed to a computing system, that includes one or more processor devices and one or more tangible, non-transitory computer-readable media that store instructions that, when executed by the one or more processor devices, cause the one or more processor devices to perform operations. The operations include receiving a plurality of vectorization requests via a plurality of active connections for a hybrid time-series vector database, wherein each of the plurality of vectorization requests comprises an input of a corresponding plurality of inputs. The plurality of inputs comprises information associated with an event, and temporal information indicative of a time at which the event occurred. The operations include processing the plurality of inputs with a machine-learned vector embedding model to generate a corresponding vector representation of a plurality of vector representations, wherein a temporal portion of the vector representation represents the temporal information. The operations include, for each of the plurality of vector representations, mapping the vector representation to a corresponding location of a plurality of locations within an embedding portion of the hybrid time-series vector database based at least in part on the temporal portion of the vector representation. The operations include receiving a query for the hybrid time-series vector database via an active connection of the plurality of active connections. The operations include, responsive to the query, retrieving a first vector representation of the plurality of vector representations based at least in part on the location to which the first vector representation is mapped.

Another example aspect of the present disclosure is directed to one or more tangible, non-transitory computer-readable media that store instructions that, when executed by one or more processor devices, cause the one or more processor devices to perform operations. The operations include receiving a plurality of vectorization requests via a plurality of active connections for a hybrid time-series vector database, wherein each of the plurality of vectorization requests comprises an input of a corresponding plurality of inputs. The plurality of inputs comprises information associated with an event, and temporal information indicative of a time at which the event occurred. The operations include processing the plurality of inputs with a machine-learned vector embedding model to generate a corresponding vector representation of a plurality of vector representations, wherein a temporal portion of the vector representation represents the temporal information. The operations include, for each of the plurality of vector representations, mapping the vector representation to a corresponding location of a plurality of locations within an embedding portion of the hybrid time-series vector database based at least in part on the temporal portion of the vector representation. The operations include receiving a query for the hybrid time-series vector database via an active connection of the plurality of active connections. The operations include, responsive to the query, retrieving a first vector representation of the plurality of vector representations based at least in part on the location to which the first vector representation is mapped.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 is a block diagram of an environment suitable for hybrid time-series vector databases that utilize large-scale parallelized connection handling to provide vector embedding services according to some implementations of the present disclosure.

FIG. 2 is a data flow diagram for providing vector embeddings as a service according to some implementations of the present disclosure.

FIG. 3 is a flowchart for hybrid time-series vector databases that utilize large-scale parallelized connection handling to provide vector embedding services according to some implementations of the present disclosure.

FIG. 4 depicts a block diagram of an example computing system 400 that provides vector embedding services according to example implementations of the present disclosure.

Reference numerals that are repeated across plural figures are intended to identify the same features in various implementations.

### DETAILED DESCRIPTION

### Overview

Generally, the present disclosure is directed to vector-based databases. More particularly, the present disclosure relates to hybrid time-series vector databases that utilize large-scale parallelized connection handling to provide vector embedding services. From a high-level view, generative machine-learned models, such as Large Language Models (LLMs), process an input and, in response, provide a generative output. In many scenarios, an input is first vectorized before being processed by the machine-learned model. Information can be vectorized when it is processed by a machine-learned vector embedding model to generate a vector representation of the input. A vector representation is a numerical vector that represents the input. By processing vectors, machine-learned models can learn to map dimensions of vectors to characteristics of the generative output.

LLMs serve as an illustrative example of how vectors can be utilized by machine-learned models. Generally, conventional LLMs will include an initial embedding layer that processes a textual input to generate a vector embedding that represents the textual input. The vector embedding can represent the textual input in a higher-dimensional space. For example, vector embedding may represent the textual input at the word-level. A word-level vector embedding may include a vector representation of each word in the textual input. The LLM can then process the vector embedding with multiple other types of layers (e.g., a linear layer, a self-attention layer, etc.) to eventually provide a generative output.

However, leveraging vector representations in the context of machine learning, and LLMs in particular, presents a number of challenges. One challenge presented by LLMs is a lack of domain-specific knowledge. While LLMs are exceptionally powerful when processing queries for more generalized information, LLMs can exhibit substantially less accuracy when queried regarding industry-specific nuances. For example, a generative output from an LLM that is responsive to a query regarding a well-known event (e.g., World War II) is likely to be accurate. However, a generative output responsive to a query regarding industry-specific nuances of semiconductor manufacturing is much less likely to be accurate.

Another challenge presented by LLMs is static learning. Specifically, LLMs are trained on large corpuses of information to provide the LLM with a wide knowledge base from which to produce generative outputs. However, conventional LLMs only reference information processed during training, and training iterations to update the knowledge base of LLMs can be prohibitively expensive. As such, LLMs often exhibit poor performance with regards to adapting to very recent information, such as identifying emerging industry trends.

Many other challenges exist with vector representations, generative models, and LLMs in particular. These challenges include, but are not limited to, contextual misunderstandings (e.g., the tendency for LLMs to overlook nuance), integration barriers, over-dependency on model accuracy, ethical and regulatory hurdles, lack of causal inference, lack of “explainability” (e.g., the capacity to explain what led to a generative output), statelessness (e.g., the inability to recall past interactions), etc.

Accordingly, implementations of the present disclosure propose hybrid time-series vector databases that utilize large-scale parallelized connection handling to provide vector embedding services. For example, assume that a computing system provides vector embedding services that leverage a hybrid time-series vector database. As described herein, a hybrid vector database refers to a database that stores both vectorized information and non-vectorized information to enable hybrid search operations, which can provide more accurate results than conventional databases. A time-series vector database refers to a database storing vector representations that represent temporal information.

The computing system can receive vectorization requests. The vectorization requests can be requests to generate a vector representation of an input for storage in the hybrid time-series vector database. Each vectorization request can include information associated with an event. For example, if the event is the activation of a sensor to measure particular values, the information associated with the event can include the particular values measured while the sensor was activated. Each vectorization request can also include temporal information that indicates a time at which the event occurred. To follow the previous example, the temporal information may indicate start and end times for activation of the sensor, a duration during which the sensor was activated, and/or precise timestamps for each value measured by the activated sensor.

The computing system can process the vectorization requests with a machine-learned vector embedding model to generate corresponding vector representations. Vector representations are also known as vector embeddings. The vector representations can numerically represent the inputs received via the vectorization requests. In addition, each vector representation can include a temporal portion that represents the temporal information of the input.

The computing system can map each of the vector representations (i.e., the vector embeddings) to a corresponding location within an embedding space. As described herein, an embedding space refers to a relatively low-dimensional space into which high-dimensional vector representations can be mapped. Generally, a distance between embeddings in an embedding space can represent a similarity between the embeddings. In other words, the closer two embeddings are located in an embedding space, the more similar they are.

Once the vector representations are mapped to the embedding space, the computing system can receive a query for the hybrid time-series vector database. In response, the computing system can retrieve one of the vector representations generated from the vectorization requests. For example, the computing system may generate a query vector representation of the query. The computing system can then perform a nearest-neighbor (NN) search (e.g., an Approximate Nearest Neighbor (ANN) search, etc.) to identify vector representations that are similar to the query vector representation. The computing system can then retrieve the vector representations most similar to the query vector representation.

Aspects of the present disclosure provide a number of technical effects and benefits. As one example technical effect and benefit, implementations described herein enable hybrid time-series vector databases that can support large-scale parallelized connections to provide vector embedding services. More specifically, many of the challenges with LLM implementation are related to a lack of information that is accessible to the LLM, such as stateful information, recent information, temporal context, industry-specific information, etc. However, implementations of the present disclosure can field vectorization requests and populate an embedding space in a massively parallelized fashion. In turn, these vector embeddings can be utilized to provide contextual information to an LLM, thus substantially increasing LLM accuracy while obviating the inefficiencies associated with additional LLM training iterations (e.g., substantial expenditure of power, memory, storage, compute cycles, etc.).

As another example technical effect and benefit, implementations of the present disclosure substantially, reduce the computational expenses associated with retrieval of information from conventional databases that is semantically similar to a query. Specifically, conventional databases may require a similarity search to be performed for each data item stored in a database, necessitating the expenditure of substantial computing resources (e.g., power, memory, compute cycles, storage, etc.). Conversely, vector database implementations of the present disclosure can determine a semantic similarity between data items in a manner that is orders of magnitude quicker and more efficient than conventional databases, therefore substantially reducing the quantity of computing resources required.

With reference now to the Figures, example embodiments of the present disclosure will be discussed in further detail.

### Example Devices and Systems

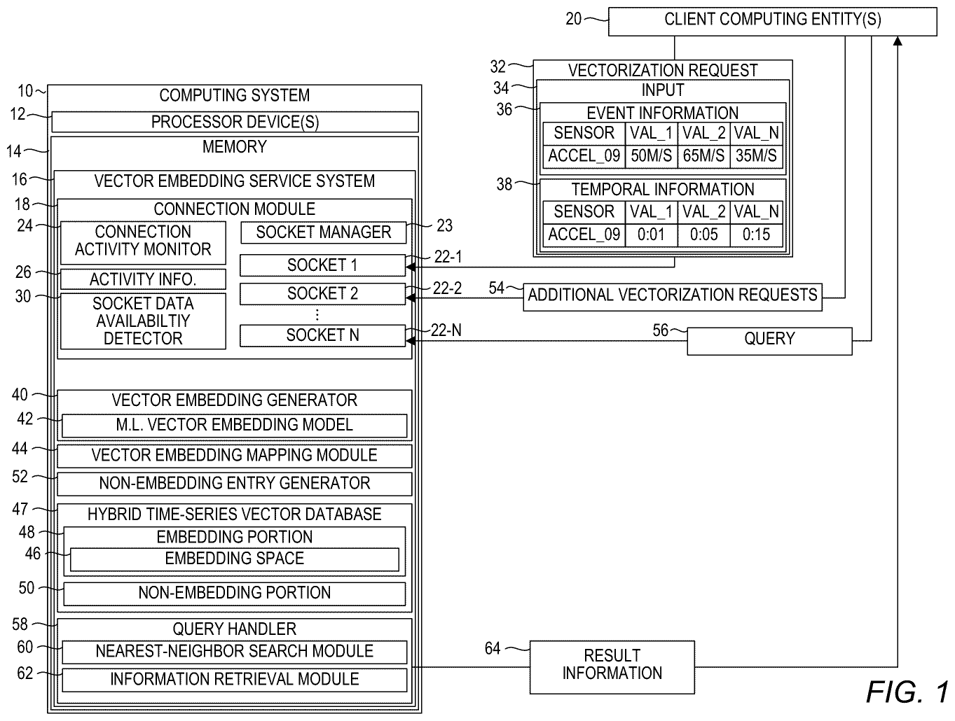

FIG. 1 is a block diagram of an environment suitable for hybrid time-series vector databases that utilize large-scale parallelized connection handling to provide vector embedding services according to some implementations of the present disclosure. A computing system 10 includes processor device(s) 12 and memory 14. In some implementations, the computing system 10 may be a computing system that includes multiple computing devices. Alternatively, in some implementations, the computing system 10 may be one or more computing devices within a computing system that includes multiple computing devices. Similarly, the processor device(s) 12 may include any computing or electronic device capable of executing software instructions to implement the functionality described herein.

The memory 14 can be or otherwise include any device(s) capable of storing data, including, but not limited to, volatile memory (random access memory, etc.), non-volatile memory, storage device(s) (e.g., hard drive(s), solid state drive(s), etc.). In particular, the memory 14 can, in some implementations, include a containerized unit of software instructions (i.e., a “packaged container”). A containerized unit of software instructions can collectively form a container that has been packaged using any type or manner of containerization technique.

The memory 14 can include a vector embedding service system 16. The vector embedding service system 16 can be a system (e.g., hardware, software, containerized software, compute resources, etc.) that implements, orchestrates, and/or provides vector embedding services. As described herein, a vector embedding services refers to a service that can generate a vector representation of an input in response to a vectorization request for storage in a database (e.g., a vector database, a hybrid vector database, a hybrid time-series vector database, etc.). In addition, the vector embedding service can enable queries to the vector database. For example, in response to a query, the vector embedding service can perform a nearest neighbor search based on a vector representation of the query.

The vector embedding service system 16 can enable large-scale parallelized connections handling. More specifically, the vector embedding service system 16 can field requests from large numbers of clients concurrently. For example, the vector embedding service system 16 can implement a multi-tenant vector database in which multiple clients access a database that is partitioned on a per-client basis. In turn, to support the multi-tenant database, the vector embedding service system can support large-scale parallelized connection handling.

To do so, the vector embedding service system 16 can include a connection module 18. The connection module 18 can manage active connections between the vector embedding service system 16 and client computing entities 20. Specifically, the connection module 18 can implement sockets 22-1-22-N (generally, sockets 22). The sockets 22 can be utilized to facilitate active connections between the vector embedding service system 16 and the client computing entities 20. The sockets 22 can be implemented using any type or manner of networking protocols or technologies. For example, the sockets 22 can be Transmission Control Protocol (TCP) sockets that include an Internet Protocol (IP) address and a corresponding port.

The connection module 18 can include a socket manager 23. The socket manager 23 can instantiate, manage, implement, de-instantiate, and otherwise orchestrate the sockets 22. The connection module 18 can include a connection activity monitor 24. The connection activity monitor 24 can monitor information or data being received via sockets 22. More specifically, if one socket utilizes substantially more resources than other sockets (e.g., exchanges substantially more information across one of the sockets 22), performance across all of the sockets 22 can be degraded. Accordingly, the connection activity monitor 24 can actively monitor sockets to identify sockets where data is currently available. The connection activity monitor 24 can indicate to the connection module 18 if data, or a certain quantity and/or type of data, is available at a particular socket. Further, the connection activity manager can generate activity information 26.

The activity information 26 can indicate historical activity on a per-socket, or per-client basis. For example, the activity information 26 can indicate a relative quantity of information that has been transmitted over each of the sockets 22. Additionally, in some implementations, the activity information 26 can include historical activity information for each of the sockets 22. For example, the activity information 26 can indicate if a particular socket of the sockets 26 has received more data than other sockets.

The connection module 18 can include a socket data availability manager 30. The socket data availability manager 30 can manage distribution of sockets for active connections between the vector embedding service system 16 and the client computing entities 20. For example, the socket data availability manager 30 can evaluate the activity information 26. Based on the activity information 26, the socket data availability manager 30 can allocate, or de-allocate, particular sockets to certain client computing entities 20. In addition, the socket data availability manager 30 can determine whether additional socket(s) should be allocated to a certain one of the client computing entities 20.

The vector embedding service system 16 can receive a vectorization request 32 from the client computing entities 20. The vectorization request 32 can be, or otherwise include, a request to generate vector representation for a particular input. Specifically, the vectorization request 32 can request that the vector embedding service system 16 generate a vector representation for an input 34. The input 34 can be an input for storage in a database, or databases, by the vector embedding service system 16. Alternatively, the input 34 can be vectorized and the vector representation can be provided to the client computing entity(s) 20 that provided the vectorization request 32.

The input 34 can include event information 36. The event information 36 can be, or otherwise include, information descriptive of event(s) that occurred at a specific time or over a specific time period. For example, assume an accelerometer sensor is programmed to begin measuring the acceleration of a computing device every ten minutes. The event information 36 can describe one of the measurement iterations that occurs every ten minutes. Specifically, the event information 36 can include the measurements captured during that particular measurement iteration. For example, if the accelerometer sensor is programmed such that, every ten minutes, the accelerometer sensor measures an acceleration of a computing device at a frequency of one measurement per second for a duration of 5 seconds, the event information 36 can include five measurements generated by the accelerometer.

It should be noted that the input 34 can be, or otherwise include, a file or other information that does not necessarily correspond to a particular event. For example, the input 34 can be a conventional type or manner of media, such as video data, textual content (e.g., a file such as .epub, .docx, .txt, .rtf, etc.), image data, or another miscellaneous type of data (e.g., spreadsheet data such as an .xml file, a slideshow such as a .ppt file, etc.).

The input 34 can include temporal information 38. The temporal information 38 can be, or otherwise include, information descriptive of particular temporal characteristics of the event information 36. To follow the previous example, if the accelerometer sensor measures an acceleration of a computing device at a frequency of one measurement per second for a duration of 5 seconds, the temporal information 38 can describe a starting time of the measurement duration, an ending time of the measurement duration, and a specific timestamp for each of the five measurements captured. In such fashion, the temporal information 38 can be utilized to populate a hybrid time-series vector database with rich information.

The vectorization request 32 can be received by the computing system 10 via the socket 22-1. Upon receipt, the vector embedding service system 16 can process the vectorization request 32 with a vector embedding generator 40. The vector embedding generator 40 can generate vector representations of inputs, such as the input 34. In particular, the vector embedding generator 40 can include a machine-learned embedding model 42. The machine-learned embedding model 42 can be a machine-learned model, such as a transformer model, that is trained to generate vector dimensional representations of inputs. For example, if the input 34 is a file including the textual content of a novel, the machine-learned embedding model 42 can process the input 34 to generate a vector representation of the input 34.

The vector embedding service system 16 can include a vector embedding mapping module 44. The vector embedding mapping module 44 can map vector embeddings generated by the machine-learned vector embedding model 42 to an embedding space 46. More specifically, assume that the vector embedding service system 16 implements a hybrid vector database 47. The hybrid vector database 47 can include an embedding portion 48 and a non-embedding portion 50. The non-embedding portion 50 can store database entries in a non-encoded format. In other words, the non-embedding portion 50 can store information in accordance with conventional database techniques. Conversely, the embedding portion 48 can store embeddings generated using the vector embedding generator 40 to implement vector database services.

To do so, the embedding portion 48 of the hybrid time-series vector database 47 can include the embedding space 46. The embedding space 46 can be a lower-dimensional deterministic space to which higher-dimensional vectors can be mapped. In particular, vectors can be embedded to a particular location within the embedding space 46. The embedding space can be a learned embedding space (e.g., learned in conjunction with the machine-learned vector embedding model 42, etc.) such that the location of a vector within the embedding space 46 can be based on the values of certain dimensions of the vector. In other words, the distance between similar vectors within the embedding space 46 can be less than the distance between dissimilar vectors within the embedding space 46.

Conversely, the vector embedding service system 16 can include a non-embedding entry generator 52 to generate database entries for the non-embedding portion 50. The non-embedding entry generator 52 can process the vectorization request 32 to generate a corresponding database entry for the non-embedding portion 50. To follow the depicted example, the non-embedding entry generator 52 may generate an entry for the input 34 that stores the type and identification of the sensor (e.g., accelerometer ACCEL_09) a database entry ID, and the corresponding vector representation or a pointer to the vector representation.

The client computing entities 20 can provide the vectorization request, and additional vectorization requests 54, to the vector embedding service system 16. In response, the vector embedding service system 16 can generate vector representations for each of the inputs. Once vectorized, the client computing entities 20 can provide a query 56 to the vector embedding service system 16. The query 56 can be a query for the hybrid time-series vector database 47.

For example, the query 56 can include a textual query. The vector embedding service system 16 can include a query handler 58. The query handler 58 can generate a query vector representation of the query using the vector embedding generator 40. The query handler 58 can then perform a nearest-neighbor search of the embedding space 46 with a nearest neighbor search module 60 to identify the vector representation of the input 34.

The query handler 58 can retrieve the information that corresponds to the vector representation of the input 34 using an information retrieval module 62. For example, upon receipt of the vectorization request 32, the vector embedding service system 16 can generate an embedding of the input 34 with the vector embedding generator 40 and can map the vector to the embedding space 46 with the vector embedding mapping module 40. The vector embedding service system 16 can also store an association between the vector representation of the input 34 and the event information 36/temporal information 38. In other words, the vector embedding service system 16 can associate the vector generated from the input 34 with the event information 36 and the temporal information 38.

The vector embedding service system 16 can search the embedding space based on the query 56 to identify the vector for the input 34. The vector embedding service system 16 can then retrieve the event information 36 and the temporal information 38 based on an association with the vector. The event information 36 and the temporal information 38 can then be provided to the client computing device(s) 20 that provided the query 56. More specifically, the vector embedding service system 16 can generate result information 64. The result information 64 can include, or otherwise be derived from, the event information 36 and/or the temporal information 38. The result information 64 can be provided to the client computing device(s) 20 that provided the query 56.

In such fashion, the hybrid time-series vector database 47 can be leveraged to provide numerous optimizations relative to conventional database technologies. Such optimizations include:
Enhanced Statefulness and Temporal Context: This includes service continuity, allowing businesses to remember previous interactions and provide a tailored user experience, and time-aware embeddings, crucial for time-series data.
Real-time Stream Processing: Embeddings can be updated instantly as new data flows in. Real-time processing means immediate insights from data, facilitating quick decision-making.
Support for Both Generative and Discriminative AI: The service's versatility ensures its applicability to a wide array of B2B needs. It can simulate normal data with generative AI and identify anomalies with discriminative AI.
Optimized Querying with Vector Databases: They facilitate fast retrievals, allowing businesses to quickly query specific embeddings. Semantic searches fetch more relevant results, enhancing the service's efficiency.
Integrated Analytics: This helps businesses to deeply analyze patterns within their data. Paired with visualization tools, businesses can better interpret their data.
Scalability and Efficiency: It's equipped to handle large datasets, ensuring that the system remains efficient even with data expansion.

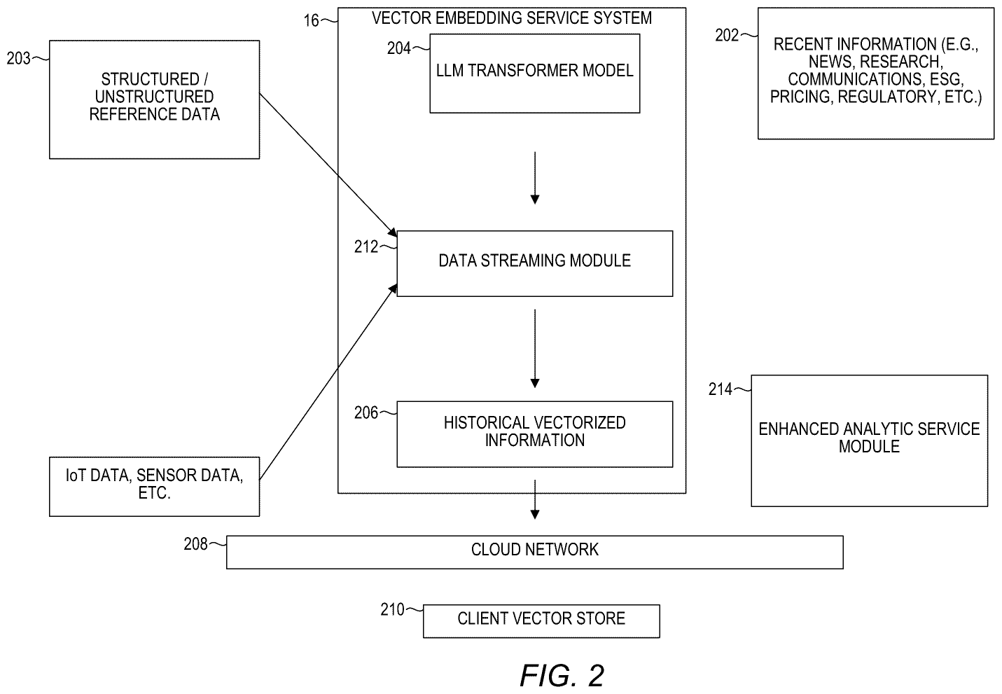

FIG. 2 is a data flow diagram for providing vector embeddings as a service according to some implementations of the present disclosure. FIG. 2 will be discussed in conjunction with FIG. 1. Specifically, recent information 202 can include news, research, communications, Environmental/Social/Governance (ESG) information, pricing information, regulatory information, etc. The recent information 202, along with structured/unstructured reference data 203, can be provided to the vector embedding service system 16. The vector embedding service system 16 can include an LLM transformer model 204. The LLM transformer model 204 can generate vector embeddings and can store the vectors in the vector embedding service system 16 (e.g., the hybrid time-series vector database 47 of the vector embedding service system 16, etc.).

The vectors, alongside historical vectorized information 206, can be streamed via a cloud network 208 to a client vectorized data store 210 using a data streaming module 212. In addition, an enhanced analytic service module 214 can be leveraged to determine the most efficient vectorization format for dissemination of all data described previously.

In such fashion, the vector embedding service system 16 can optimize vector processing for a number of different use cases. For example, the vector embedding service system 16 can provide vector embedding services for the following use-cases:
Manufacturing: the vector embedding service system 16 can facilitate supply chain optimization, quality assurance, and predictive maintenance.
Life Sciences & Healthcare: the vector embedding service system 16 can enable personalized treatment, drug discovery, and epidemic outbreak predictions.
Energy & Utilities: the vector embedding service system 16 can assist in demand forecasting, optimized resource allocation, and sustainability initiatives.
Telecommunications: the vector embedding service system 16 can enable network maintenance, customer churn prediction, and optimized content delivery.
Global System Integrators (GSIs): the vector embedding service system 16 can enhance project management and lead to holistic solutions and integrations.
High Tech Software Companies/ISVs: the vector embedding service system 16 can help in software bug prediction, UX enhancement, and license optimization.

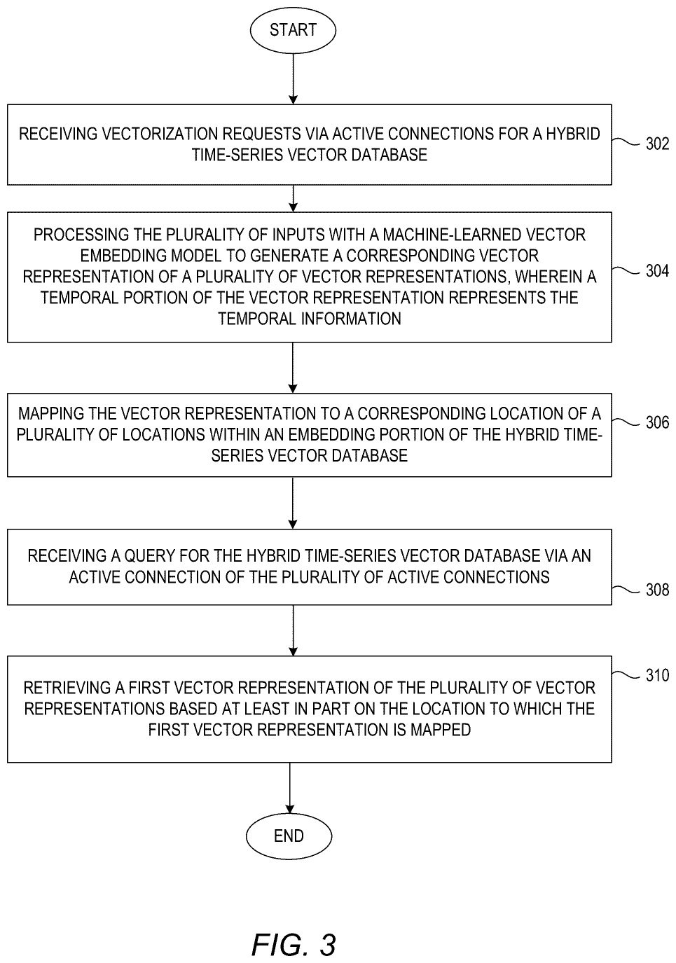

FIG. 3 is a flowchart for hybrid time-series vector databases that utilize large-scale parallelized connection handling to provide vector embedding services according to some implementations of the present disclosure. Although FIG. 3 depicts steps performed in a particular order for purposes of illustration and discussion, the methods of the present disclosure are not limited to the particularly illustrated order or arrangement. The various steps of the method can be omitted, rearranged, combined, and/or adapted in various ways without deviating from the scope of the present disclosure.

At operation 302, a computing system can receive a plurality of vectorization requests via a plurality of active connections for a hybrid time-series vector database. Each of the plurality of vectorization requests can include an input of a corresponding plurality of inputs. The plurality of inputs can include information associated with an event, and temporal information indicative of a time at which the event occurred.

At operation 304, the computing system can process the plurality of inputs with a machine-learned vector embedding model to generate a corresponding vector representation of a plurality of vector representations. The temporal portion of the vector representation can represent the temporal information.

At operation 306, for each of the plurality of vector representations, the computing system can map the vector representation to a corresponding location of a plurality of locations within an embedding portion of the hybrid time-series vector database based at least in part on the temporal portion of the vector representation.

At 308, the computing system can receive a query for the hybrid time-series vector database via an active connection of the plurality of active connections.

At 310, responsive to the query, the computing system can retrieve a first vector representation of the plurality of vector representations based at least in part on the location to which the first vector representation is mapped.

In some implementations, retrieving the first vector representation of the plurality of vector representations can include processing the query with the machine-learned vector embedding model to generate a query vector representation. The computing system can, based on the query vector representation, perform a nearest-neighbor search with the hybrid time-series vector database to retrieve the first vector representation.

In some implementations, the computing system can process the query vector representation and the first vector representation with a machine-learned generative model to obtain a generative output. The computing system can provide the generative output to via the active connection of the plurality of active connections.

In some implementations, the computing system can receive a data storage request via the active connection of the plurality of active connections, wherein the active storage request comprises textual content for storage to the hybrid time-series vector database. The computing system can store a data entry to a non-embedding portion of the hybrid time-series database, wherein the data entry comprises the textual content.

In some implementations, the computing system can receive a second query via the active connection of the plurality of active connections. The computing system can, responsive to the query, retrieve a second vector representation of the plurality of vector representations based at least in part on the historical information and the location to which the second vector representation is mapped.

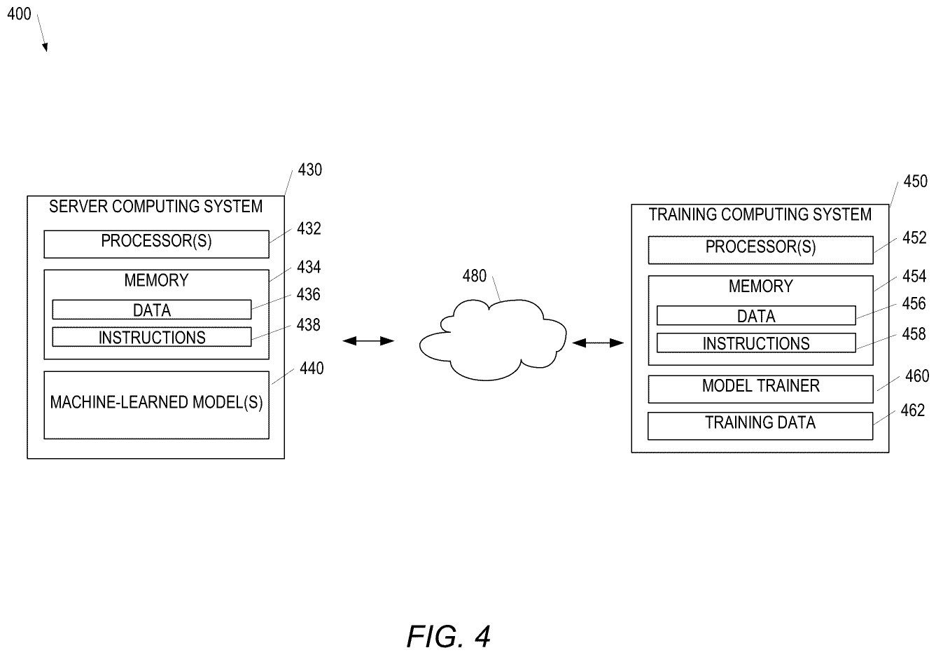

FIG. 4 depicts a block diagram of an example computing system 400 that provides vector embedding services according to example implementations of the present disclosure. The system 400 includes a server computing system 430 and a training computing system 450 that are communicatively coupled over a network 480.

The server computing system 430 includes one or more processors 432 and a memory 434. The one or more processors 432 can be any suitable processing device (e.g., a processor core, a microprocessor, an ASIC, an FPGA, a controller, a microcontroller, etc.) and can be one processor or a plurality of processors that are operatively connected. The memory 434 can include one or more non-transitory computer-readable storage media, such as RAM, ROM, EEPROM, EPROM, flash memory devices, magnetic disks, etc., and combinations thereof. The memory 434 can store data 436 and instructions 438 which are executed by the processor 432 to cause the server computing system 430 to perform operations.

In some implementations, the server computing system 430 includes or is otherwise implemented by one or more server computing devices, virtualized computing devices, compute nodes, compute instances, etc. If the server computing system includes a plurality of computing devices, the multiple computing devices can operate according to sequential computing architectures, parallel computing architectures, or some combination thereof.

The server computing system 430 can store or otherwise include one or more machine-learned models 440. For example, the models 440 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). In particular, the machine-learned models 440 can include foundational models with many parameters trained using large quantities of information. Examples of such models include large language models.

The server computing system 430 can train the model(s) 440 via interaction with a training computing system 450 that is communicatively coupled over the network 480. The training computing system 450 can be separate from the server computing system 430 or can be a portion of the server computing system 430.

The training computing system 450 includes one or more processors 452 and a memory 454. The one or more processors 452 can be any suitable processing device (e.g., a processor core, a microprocessor, an ASIC, an FPGA, a controller, a microcontroller, etc.) and can be one processor or a plurality of processors that are operatively connected. The memory 454 can include one or more non-transitory computer-readable storage media. For example, the memory 454 can include RAM, ROM, flash memory devices, etc. The memory 454 can store data 456 and instructions 458 which are executed by the processor 452 to cause the training computing system 450 to perform operations. In some implementations, the training computing system 450 includes or is otherwise implemented by one or more server computing devices.

The training computing system 450 can include a model trainer 460 that is capable of training machine-learned models. Specifically, the model trainer 460 can train the machine-learned model(s) 440 implemented by the server computing system 430 using various training or learning techniques. For example, the training computing system can implement training techniques such as backwards propagation of errors. To follow the previous example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Where possible, gradient descent techniques can be used to iteratively update the parameters over a number of training iterations.

In some implementations, performing backwards propagation of errors can include performing truncated backpropagation through time. The model trainer 460 can perform a number of generalization techniques (e.g., weight decays, dropouts, etc.) to improve the generalization capability of the models being trained. The model trainer 460 can train the models 440 based on a set of training data 462. The training data 462 can include, for example, a large quantity of training information sufficient to train a foundational model to perform multiple types of tasks.

The model trainer 460 includes computer logic utilized to provide desired functionality. The model trainer 460 can be implemented in hardware, firmware, and/or software controlling a processor. For example, in some implementations, the model trainer 460 includes programmatic instructions stored on a storage device, loaded into a memory and executed by one or more processors. In other implementations, the model trainer 460 includes one or more sets of computer-executable instructions that are stored in a tangible computer-readable storage medium such as RAM, hard disk, or optical or magnetic media.

The network 480 can be any type of communications network, such as a local area network (e.g., intranet), wide area network (e.g., Internet), or some combination thereof and can include any number of wired or wireless links. In general, communication over the network 480 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. As an example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for vector embedding via hybrid time-series vector databases, comprising:
receiving, by a computing system comprising one or more processor devices, a plurality of vectorization requests via a plurality of active connections for a hybrid time-series vector database, wherein each of the plurality of vectorization requests comprises an input of a corresponding plurality of inputs, and wherein of the plurality of inputs comprises:
information associated with an event; and
temporal information indicative of a time at which the event occurred;
processing, by the computing system, the plurality of inputs with a machine-learned vector embedding model to generate a corresponding vector representation of a plurality of vector representations, wherein a temporal portion of the vector representation represents the temporal information;
for each of the plurality of vector representations, mapping, by the computing system, the vector representation to a corresponding location of a plurality of locations within an embedding portion of the hybrid time-series vector database based at least in part on the temporal portion of the vector representation;
receiving, by the computing system, a query for the hybrid time-series vector database via an active connection of the plurality of active connections; and
responsive to the query, retrieving, by the computing system, a first vector representation of the plurality of vector representations based at least in part on the location to which the first vector representation is mapped.

2. The method of claim 1, wherein retrieving the first vector representation of the plurality of vector representations comprises:
processing, by the computing system, the query with the machine-learned vector embedding model to generate a query vector representation;
based on the query vector representation, performing, by the computing system, a nearest-neighbor search with the hybrid time-series vector database to retrieve the first vector representation.

3. The method of claim 2, wherein the method further comprises:
processing, by the computing system, the query vector representation and the first vector representation with a machine-learned generative model to obtain a generative output; and
providing, by the computing system, the generative output to via the active connection of the plurality of active connections.

4. The method of claim 1, wherein the method further comprises:
receiving, by the computing system, a data storage request via the active connection of the plurality of active connections, wherein the active storage request comprises textual content for storage to the hybrid time-series vector database; and
storing, by the computing system, a data entry to a non-embedding portion of the hybrid time-series database, wherein the data entry comprises the textual content.

5. The method of claim 1, wherein the method further comprises:
storing, by the computing system, historical information descriptive of the query and the first vector representation to the hybrid vector database.

6. The method of claim 5, wherein the method further comprises:
receiving, by the computing system, a second query via the active connection of the plurality of active connections; and
responsive to the query, retrieving, by the computing system, a second vector representation of the plurality of vector representations based at least in part on the historical information and the location to which the second vector representation is mapped.

7. The method of claim 1, wherein the information associated with the event comprises a plurality of sensor measurements collected during a sensor activation event.

8. A computing system, comprising:
one or more processor devices;
one or more tangible, non-transitory computer-readable media that store instructions that, when executed by the one or more processor devices, cause the one or more processor devices to perform operations, the operations comprising:
receiving a plurality of vectorization requests via a plurality of active connections for a hybrid time-series vector database, wherein each of the plurality of vectorization requests comprises an input of a corresponding plurality of inputs, and wherein of the plurality of inputs comprises:
information associated with an event; and
temporal information indicative of a time at which the event occurred;
processing the plurality of inputs with a machine-learned vector embedding model to generate a corresponding vector representation of a plurality of vector representations, wherein a temporal portion of the vector representation represents the temporal information;
for each of the plurality of vector representations, mapping the vector representation to a corresponding location of a plurality of locations within an embedding portion of the hybrid time-series vector database based at least in part on the temporal portion of the vector representation;
receiving a query for the hybrid time-series vector database via an active connection of the plurality of active connections; and
responsive to the query, retrieving a first vector representation of the plurality of vector representations based at least in part on the location to which the first vector representation is mapped.

9. One or more tangible, non-transitory computer-readable media that store instructions that, when executed by one or more processor devices, cause the one or more processor devices to perform operations, the operations comprising:
receiving a plurality of vectorization requests via a plurality of active connections for a hybrid time-series vector database, wherein each of the plurality of vectorization requests comprises an input of a corresponding plurality of inputs, and wherein of the plurality of inputs comprises:
information associated with an event; and
temporal information indicative of a time at which the event occurred;
processing the plurality of inputs with a machine-learned vector embedding model to generate a corresponding vector representation of a plurality of vector representations, wherein a temporal portion of the vector representation represents the temporal information;
for each of the plurality of vector representations, mapping the vector representation to a corresponding location of a plurality of locations within an embedding portion of the hybrid time-series vector database based at least in part on the temporal portion of the vector representation;
receiving a query for the hybrid time-series vector database via an active connection of the plurality of active connections; and
responsive to the query, retrieving a first vector representation of the plurality of vector representations based at least in part on the location to which the first vector representation is mapped.

10. The one or more tangible, non-transitory computer-readable media of claim 9, wherein retrieving the first vector representation of the plurality of vector representations comprises:
processing the query with the machine-learned vector embedding model to generate a query vector representation; and
based on the query vector representation, performing a nearest-neighbor search with the hybrid time-series vector database to retrieve the first vector representation.

11. The one or more tangible, non-transitory computer-readable media of claim 10, wherein the operations further comprise:
processing the query vector representation and the first vector representation with a machine-learned generative model to obtain a generative output; and
providing the generative output to via the active connection of the plurality of active connections.

12. The one or more tangible, non-transitory computer-readable media of claim 9, wherein the operations further comprise:
receiving a data storage request via the active connection of the plurality of active connections, wherein the active storage request comprises textual content for storage to the hybrid time-series vector database; and
storing a data entry to a non-embedding portion of the hybrid time-series database, wherein the data entry comprises the textual content.

13. The one or more tangible, non-transitory computer-readable media of claim 9, wherein the operations further comprise:
storing historical information descriptive of the query and the first vector representation to the hybrid vector database.

14. The one or more tangible, non-transitory computer-readable media of claim 13, wherein the operations further comprise:
receiving a second query via the active connection of the plurality of active connections; and
responsive to the query, retrieving a second vector representation of the plurality of vector representations based at least in part on the historical information and the location to which the second vector representation is mapped.

15. The one or more tangible, non-transitory computer-readable media of claim 9, wherein the method further comprises:
processing one or more inputs with a machine-learned model to obtain a model output, wherein the one or more inputs comprises at least one of:
(a) the vector representation; or
(b) information represented by the vector representation; and
wherein the machine-learned model is trained to process information indicative of transactions to generate a fraud detection output.

16. The one or more tangible, non-transitory computer-readable media of claim 9, wherein the method further comprises:
processing a set of inputs with a machine-learned model to obtain a model output, wherein the set of inputs comprises:
(a) the vector representation or information derived from the vector representation; and
(b) the query or a vector representation of the query; and
wherein the machine-learned model is trained to process a query and a set of contextual information to generate a generative output, wherein the generative output is responsive to the query, and wherein the generative output is conditioned on the contextual information.

17. The one or more tangible, non-transitory computer-readable media of claim 9, wherein the method further comprises:
processing one or more inputs with a machine-learned model to obtain a model output, wherein the one or more inputs comprises at least one of:
(a) the vector representation; or
(b) information represented by the vector representation; and
wherein the machine-learned model is trained to process information indicative of satellite imagery to generate a predictive output.

18. The one or more tangible, non-transitory computer-readable media of claim 9, wherein the method further comprises:
processing one or more inputs with a machine-learned model to obtain a model output, wherein the one or more inputs comprises at least one of:
(a) the vector representation; or
(b) information represented by the vector representation; and
wherein the machine-learned model is trained to process information indicative of agricultural sensor readings to generate a agricultural prediction output.

19. The one or more tangible, non-transitory computer-readable media of claim 9, wherein the method further comprises:
processing one or more inputs with a machine-learned model to obtain a model output, wherein the one or more inputs comprises at least one of:
(a) the vector representation; or
(b) information represented by the vector representation; and
wherein the machine-learned model is trained to process information descriptive of a state of a particular industry to generate an industry-specific prediction output.

20. The one or more tangible, non-transitory computer-readable media of claim 9, wherein the method further comprises:
processing one or more inputs with a machine-learned model to obtain a model output, wherein the one or more inputs comprises at least one of:
(a) the vector representation; or
(b) information represented by the vector representation; and
wherein the machine-learned model is trained to process health-related information to generate a model output, wherein the model output comprises:
information indicative of a predicted drug compound;
information indicative of a predicted epidemic outbreak; or information indicative of one or more predicted treatments for a particular user.
